(19) United States
(12) Patent Application Publication
(10) Pub. No.: US 2007/0254697 A1
(43) Pub. Date: Nov. 1, 2007

(54) Mobile Terminal Device

(75) Inventors: Toshiyasu Sugio, Osaka (JP); Satoshi Kondo, Kyoto (JP); Masayasu Iguchi, Hyoto (JP); Takahiro Nishi, Nara (JP); Tadamasa Toma, Osaka (JP); Hisao Sasai, Osaka (JP)

Correspondence Address: STEPTOE & JOHNSON LLP, 1330 CONNECTICUT AVE., NW, WASHINGTON, DC, 20036, US

(73) Assignee: Matsushita Eleactric Industrial Co., Ltd., Kadoma-shi, Osaka (JP)

(21) Appl. No.: 11/661,919

(22) PCT Filed: Sep. 5, 2005
(86) PCT No.: PCT/JP05/16216

§ 371 Date: Mar. 5, 2007

(30) Foreign Application Priority Data
Sep. 6, 2004 (JP) 2004-258934

(51) Int. Cl. H04M 1/00

(52) U.S. Cl. 455/556.2

(57) ABSTRACT

The present invention is a mobile terminal device comprising a data transmission/reception unit (103) for transmitting and receiving data, a memory unit (104) or a memory card unit (105) for storing data, a main power supply (109), a secondary power supply (110), an emergency data transmission unit (112) for transmitting data to a predetermined server, terminal, or external device, and an emergency mode control unit (102) for, when the data transmission/reception unit (103) receives data for setting an emergency mode, setting the power supply so as not to be turned off, and controlling the emergency data transmission unit (112) so as to save the data stored in the memory unit (104) or the memory card unit (105) into the predetermined server, terminal, or external device. According to the mobile terminal device of the present invention, when there occurs loss, or theft, or accident that might lose important data, protection of the important data and prevention of unauthorized use can be reliably carried out.

### TECHNICAL FIELD

The present invention relates to a mobile terminal device and, more particularly, a mobile terminal device for saving important data such as personal information data stored in a memory, into another terminal, a server, or an external device, during an emergency mode.

### BACKGROUND ART

In recent years, mobile terminal devices such as handy phones have been increasingly sophisticated, and functions such as electronic money, credit, and the like have been added to the mobile terminal devices, thereby increasing the values of the mobile terminal devices. Further, the values of data stored in memories in the mobile terminal devices have also been increased. Therefore, the necessity of preventing unauthorized use of a mobile terminal device and protecting important information such as personal data stored in a memory when the mobile terminal device is lost or stolen, has been increased.

Conventionally, a handy phone system which prevents unauthorized use of a handy phone and notifies the owner of the position of the handy phone when the handy phone as a mobile terminal device is lost or stolen, has been proposed (for example, refer to Patent Document 1). In the handy phone system described in Patent Document 1, when the owner becomes aware of the loss or theft of the handy phone and transmits an arbitrary password to the handy phone from another phone, the handy phone locks its operation unit. Thereby, unauthorized use of the handy phone is prevented. Further, in this system, when the handy phone receives the password, the handy phone detects its position and transmits the position information to the base station, thereby notifying the owner of the position of the handy phone.

Further, a handy phone which performs position notification, prevention of unauthorized use, and protection of personal data when it is lost or stolen, has also been proposed (Patent Document 2). When the handy phone described in Patent Document 2 receives an e-mail including a previously set command character sequence, it automatically transmits a picture that is shot by an attached camera to notify the owner of the position of the handy phone. Further, when this handy phone receives the e-mail, it replaces personal data with fanciful data and displays the fanciful data to protect the personal data. Further, the handy phone automatically cuts the power supply after a predetermined period of time has passed from the reception of the e-mail to prevent unauthorized use.

Furthermore, a handy phone which protects data in a memory and prevents unauthorized use when it is lost or stolen has also been proposed (Patent Document 3). When the handy phone described in Patent Document 3 receives a code number and a backup data request from a control device that is connected to a telephone exchange center, the handy phone collates the received code number with a code number that has previously been stored. When the code numbers coincide with each other, the handy phone transfers the backup data to the user terminal unit through the base station or the exchange center, or encrypts the backup data. Thereafter, the handy phone turns off the communication function and the display function. Thereby, the data stored in the memory are protected, and unauthorized use of the data is prevented.

Patent Document 1: Japanese Published Patent Application No. 2003-143649

Patent Document 2: Japanese Published Patent Application No. 2004-112126

Patent Document 3: Japanese Published Patent Application No. 2004-32402

Patent Document 4: Japanese Published Patent Application No. 2001-197175

### DISCLOSURE OF THE INVENTION

### Problems to be Solved by the Invention

The inventions described in Patent Documents 1˜3 have the following drawbacks. In the invention described in Patent Document 1, when the handy phone is stolen or lost, in order to make the handy phone start the operation of preventing unauthorized use or the operation of informing the position of the handy phone, it is necessary for the owner to transmit an arbitrary password to the handy phone from another phone. Likewise, in the invention described in Patent Document 2, it is necessary to transmit an e-mail including a command character sequence to the handy phone. Further, in the invention described in Patent Document 3, in order to make the handy phone start the operation of protecting the data stored in the memory, it is necessary to transmit a code number to the handy phone from the control device. However, the abuser does not always turn on the power supply of the handy phone, and there is a possibility that the abuser turns on the handy phone only when he/she uses it. Since the handy phone cannot receive a mail, call, password, or code number unless it is powered on, if the abuser does not turn on the power supply of the handy phone, the handy phone cannot start the operation for prevention of unauthorized use, position notification, or data protection, in the inventions disclosed in Patent Documents 1˜3.

Further, in the invention of Patent Document 1, when the handy phone receives an arbitrary password, it locks the operation unit to prevent unauthorized use, and transmits the position information. However, the handy phone cannot perform these operations unless it is powered on. Accordingly, even when the handy phone receives the arbitrary password, if the power supply is turned off by the abuser, the handy phone can perform neither the operation of preventing unauthorized use nor the operation of informing its position. Likewise, also in the invention of Patent Document 2, even when the handy phone receives the mail including the command character sequence, if the power supply is turned off by the abuser, the handy phone can perform neither the operation of informing its position by transmitting the camera-shot image, nor the operation of protecting the personal data by displaying the fanciful data instead of the personal data. Also in the invention of Patent Document 3, even when the handy phone receives the code number, if the power supply is turned off by the abuser, the handy phone cannot perform the operation of protecting the data by transmitting the backup data or encrypting the backup data.

Accordingly, in order to solve the above-mentioned problems, it is an object of the present invention to provide a mobile terminal device that can reliably perform the operation of preventing unauthorized use and the operation of protecting important data, when the mobile terminal device is lost or stolen, or an accident that might lose the important data occurs.

### Measures to Solve the Problems

A mobile terminal device according to the present invention comprises a main power supply for supplying power, a data transmission/reception unit for transmitting and receiving data, a memory unit for storing data, an emergency data transmission unit for transmitting data to a predetermined server, terminal, or external device, and a control unit for making the main power supply not to be turned off when the data transmission/reception unit receives data for setting an emergency mode, and in this state, controlling the emergency data transmission unit so as to transmit the data stored in the memory unit to the predetermined server, terminal, or external device.

According to the present invention, in the above-described mobile terminal device, the memory unit stores a phone number for emergency, and when the data transmission/reception unit receives data of the phone number for emergency as the data for setting the emergency mode, the control unit makes the main power supply not to be turned off, and in this state, controls the emergency data transmission unit so as to transmit the data stored in the memory unit to the predetermined server, terminal, or external device.

According to the present invention, in the above-described mobile terminal device, the memory unit stores a mail address for emergency, and when the data transmission/reception unit receives data of the mail address for emergency as the data for setting the emergency mode, the control unit makes the main power supply not to be turned off, and in this state, controls the emergency data transmission unit so as to transmit the data stored in the memory unit to the predetermined server, terminal, or external device.

According to the present invention, in the above-described mobile terminal device, the memory unit stores a passcode for emergency, and when the data transmission/reception unit receives the passcode for emergency as the data for setting the emergency mode, the control unit makes the main power supply not to be turned off, and in this state, controls the emergency data transmission unit so as to transmit the data stored in the memory unit to the predetermined server, terminal, or external device.

According to the present invention, the above-described mobile terminal device further includes a position detection unit for detecting the position of the mobile terminal device, and outputting position information data, and the control unit controls the emergency data transmission unit so as to transmit the position information data to the predetermined server, terminal, or external device, when the data transmission/reception unit receives the data for setting the emergency mode.

According to the present invention, the above-described mobile terminal device further includes a shooting unit for shooting surrounding circumferences, and outputting shot picture data, and the control unit controls the emergency data transmission unit so as to transmit the shot picture data to the predetermined server, terminal, or external device, when the data transmission/reception unit receives the data for setting the emergency mode.

According to the present invention, the above-described mobile terminal device further includes an audio detection unit for detecting surrounding sounds, and outputting audio data, and the control unit controls the emergency data transmission unit so as to transmit the audio data to the predetermined server, terminal, or external device, when the data transmission/reception unit receives the data for setting the emergency mode.

According to the present invention, the above-described mobile terminal device further includes a secondary power supply, and the control unit controls the second power supply so as to supply power, if the main power supply cannot supply power when the data transmission/reception unit receives the data for setting the emergency mode.

According to the present invention, the above-described mobile terminal device further includes a warning beep generation unit for generating warning beep, and the control unit controls the warning beep generation unit so as to generate warning beep, when the data transmission/reception unit receives the data for setting the emergency mode.

According to the present invention, in the above-described mobile terminal device, the memory unit stores backup history indicating the history of data which have been transmitted in the past from the memory unit to the predetermined server, terminal, or external device, and the control unit controls the emergency data transmission unit so as to transmit data which has a change in its data name or data size from the data remaining in the backup history, as difference data, to the predetermined server, terminal, or external device, when the data transmission/reception unit receives the data for setting the emergency mode.

According to the present invention, the above-described mobile terminal device further includes a water damage detection unit for detecting the degree of water damage on the mobile terminal device, and a submersion detection unit for detecting whether the mobile terminal device is submerged or not, based on whether a detected value by the water damage detection unit exceeds a threshold value or not, and transmitting the data for setting the emergency mode to the data transmission/reception unit when submersion of the mobile terminal device is detected.

According to the present invention, the above-described mobile terminal device further includes an acceleration measurement unit for measuring the acceleration of motion of the mobile terminal device, and a dropping detection unit for detecting whether the mobile terminal device is being dropped or not, based on whether the acceleration measured by the acceleration measurement unit exceeds a threshold value or not, and transmitting the data for setting the emergency mode to the data transmission/reception unit when dropping of the mobile terminal device is detected.

### EFFECTS OF THE INVENTION

As described above, according to the mobile terminal device of the present invention, when the data transmission/reception unit receives the data for setting the emergency mode, the power supply is made not to be turned off, and in this state, the data stored in the memory unit are transmitted to the predetermined server, terminal, or external device. Therefore, even when the mobile terminal device is lost, stolen, submerged, or dropped, the operation in the emergency mode is reliably carried out, thereby protecting important data such as personal information data.

Furthermore, the mobile terminal device of the present invention is provided with the position detection unit for detecting the position of the mobile terminal device to output position information data, the shooting unit for shooting surrounding circumferences to output shot picture data, and the audio detection unit for detecting surrounding sounds to output audio data, and when the data transmission/reception unit receives the data for setting the emergency mode, the power supply is controlled so as not to be turned off, and in this state, the position information data, the shot picture data, or the audio data is transmitted to the predetermined server, terminal, or external device. Therefore, when the mobile terminal device is lost or stolen, the operation in the emergency mode is reliably carried out, whereby the current position can be continuously informed to the predetermined server, terminal, or external device.

Furthermore, the mobile terminal device of the present invention is provided with the warning beep generation unit for generating warning beep, and when the data transmission/reception unit receives the data for setting the emergency mode, the power supply is made not to be turned off, and in this state, the warning beep generation unit outputs warning beep. Therefore, when the mobile terminal device is lost or stolen, the operation in the emergency mode is reliably carried out, whereby the warning beep can be continuously outputted. As a result, unauthorized use by an abuser can be avoided.

Furthermore, according to the mobile terminal device of the present invention, when the data for setting the emergency mode is received and the data stored in the memory unit is transmitted to the predetermined server, terminal, or external device, the backup history indicating the history of data which have been transmitted in the past from the memory unit to the predetermined server, terminal, or external device is searched, and data whose data name or data size is changed from the data remaining in the backup history is transmitted as difference data. Therefore, the amount of data to be saved during the emergency mode is reduced to shorten the data saving time.

### BRIEF DESCRIPTION OF THE DRAWINGS

FIG. 1 is a block diagram illustrating an example of construction of a mobile terminal device according to a first embodiment of the present invention.

FIG. 2 is a flowchart for explaining the operation of the mobile terminal device according to the first embodiment of the present invention.

FIG. 3 is a flowchart for explaining the operation of the mobile terminal device according to the first embodiment of the present invention.

FIG. 4 is a flowchart for explaining the operation of the mobile terminal device according to the first embodiment of the present invention.

FIG. 5 is a flowchart for explaining the operation of the mobile terminal device according to the first embodiment of the present invention.

FIG. 6 is a block diagram illustrating an example of construction of a mobile terminal device according to a second embodiment of the present invention.

FIG. 7 is a flowchart for explaining the operation of the mobile terminal device according to the second embodiment of the present invention.

FIG. 8 is a block diagram illustrating an example of construction of a mobile terminal device according to a third embodiment of the present invention.

FIG. 9 is a flowchart for explaining the operation of the mobile terminal device according to the third embodiment of the present invention.

FIG. 10 is a diagram illustrating the relationship between the mobile terminal device of the present invention and other devices.

### DESCRIPTION OF REFERENCE NUMERALS

101 . . . normal mode control unit

102 . . . emergency mode control unit

103 . . . data transmission/reception unit

104 . . . memory unit

105 . . . memory card unit

106 . . . position detection unit

107 . . . camera shooting unit

108 . . . audio detection unit

109 . . . main power supply

110 . . . secondary power supply

111 . . . warning beep generation unit

112 . . . emergency data transmission unit

601 . . . water damage detection unit

602 . . . submersion detection unit

801 . . . acceleration measurement unit

802 . . . dropping detection unit

1001a˜1001c . . . mobile terminal device

1002 . . . telephone

1003 . . . personal computer

1005 . . . mobile terminal

1006 . . . household electrical appliance

### BEST MODE TO EXECUTE THE INVENTION

### Embodiment 1

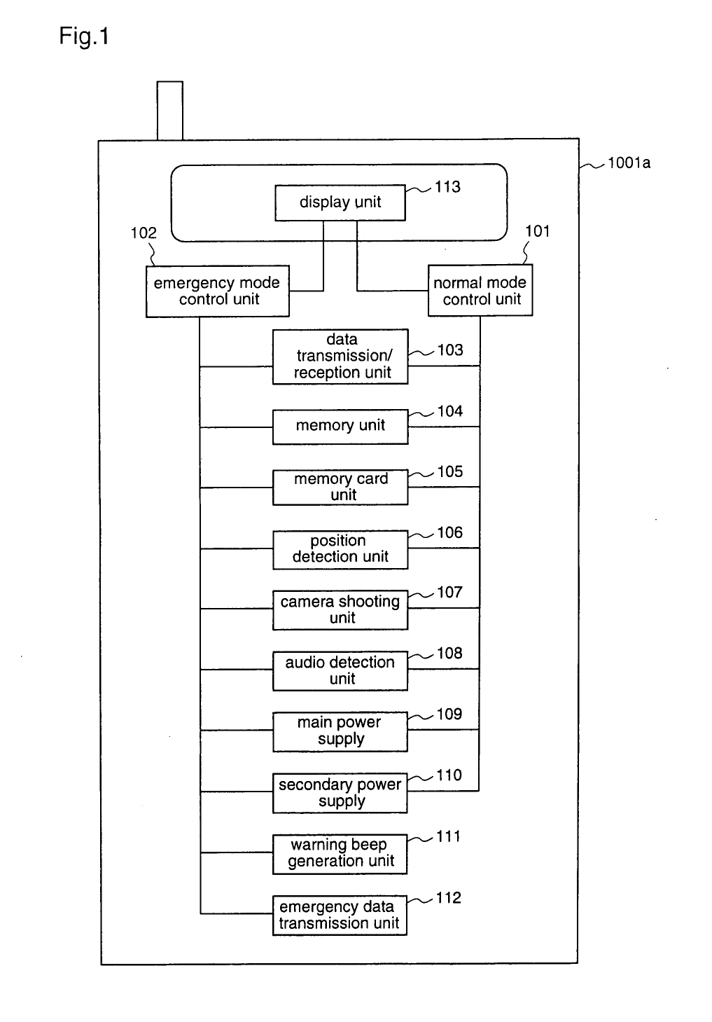

FIG. 1 is a block diagram illustrating a mobile terminal device according to a first embodiment of the present invention. Although FIG. 1 shows a handy phone as an example of a mobile terminal device, a notebook computer or another mobile terminal device may be employed.

A mobile terminal device 1001a according to the first embodiment of the invention comprises a normal mode control unit 101 for controlling the respective parts of the mobile terminal device in a normal mode, an emergency mode control unit 102 for controlling the respective parts of the mobile terminal device in an emergency mode, a data transmission/reception unit 103, a memory unit 104, a memory card unit 105 to/from which a memory card can be attached/detached, a position detection unit 106 for detecting a position of the mobile terminal device, a camera shooting unit 107, an audio detection unit 108 for detecting surrounding sounds, a main power supply 109, a secondary power supply 110, a warning beep generation unit 111 for outputting warning beep in the emergency mode, an emergency data transmission unit 112, and a display unit 113.

The data transmission/reception unit 103 transmits/receives phone calls, mails, or other data to/from telephones, servers, other terminals, or external devices. The data transmission/reception unit 103 also receives data from the respective units in the mobile terminal device.

The memory unit 104 or the memory card unit 105 holds data as follows: phone address book, mail address book, transmission/reception history of calls and mails, personal data, phone number of emergency, mail address for emergency, passcode for emergency, camera shots, data of a place in which data are saved during the emergency mode (e.g., information of server, terminal, or external device), and backup history indicating the history of data that have been saved in the past. The normal mode control unit 101 stores the phone number for emergency, the mail address for emergency, and the passcode for emergency in the memory unit 104 or the memory card unit 105, during the normal mode, according to an instruction from the owner.

The memory card unit 105 has a lock function that prevents a memory card from being detached from a slot. To be specific, the memory card unit 105 has a function of fixing the memory card by utilizing the shape of the memory card, for example, a function of hooking a notch of the memory card, or a function of closing a lid that keeps the memory card inside. Applicable mobile terminal devices may be registered on the memory card to be inserted in the memory card unit 105.

The emergency data transmission unit 112 transmits the data to a predetermined server, terminal, or external device during the emergency mode, based on control of the emergency mode control unit 102. For example, there is an electrical household appliance as an external device.

A description will be given of the operation of the mobile terminal device 1001a according to the first embodiment when it is lost or stolen. Since the operation in the normal mode is not a main subject of the present invention, description thereof will be omitted.

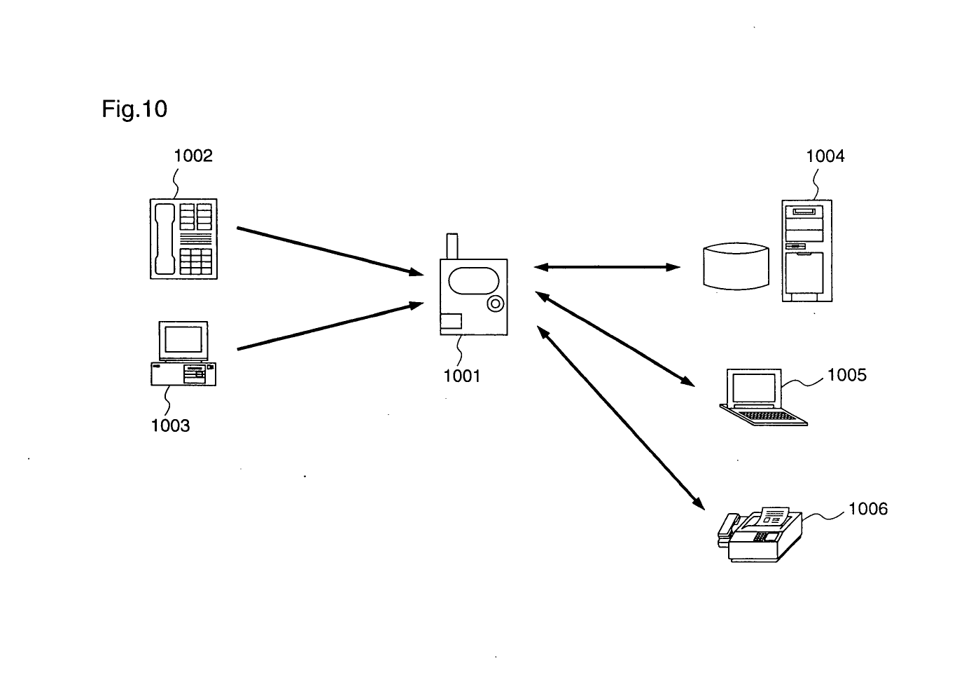

Initially, a description will be given of the operation for setting the emergency mode on the mobile terminal device when the mobile terminal device is lost or stolen, with reference to FIG. 10. When the mobile terminal device is lost or stolen, the owner transmits data for setting the emergency mode to the mobile terminal device 1001. As the data for setting the emergency mode, there are data of a phone number for emergency, data of a mail address for emergency, and a passcode for emergency. For example, the owner makes a phone call to the mobile terminal device 1001 from a telephone set 1002 of the emergency phone number to transmit the data of the emergency phone number to the mobile terminal device 1001, or the owner transmits a mail to the mobile terminal device 1001 from a personal computer 1003, a server 1004, or a mobile terminal 1005 having the emergency mail address, thereby transmitting the data of the emergency mail address to the mobile terminal device 1001. Alternatively, the owner may transmit the data of the emergency phone number, the data of the emergency mail address, or the emergency passcode from the personal computer 1003, the server 1004, or the mobile terminal 1005 through the Internet. As for the emergency passcode, there may be employed a character sequence, a number sequence, and a combination of a character sequence and a number sequence.

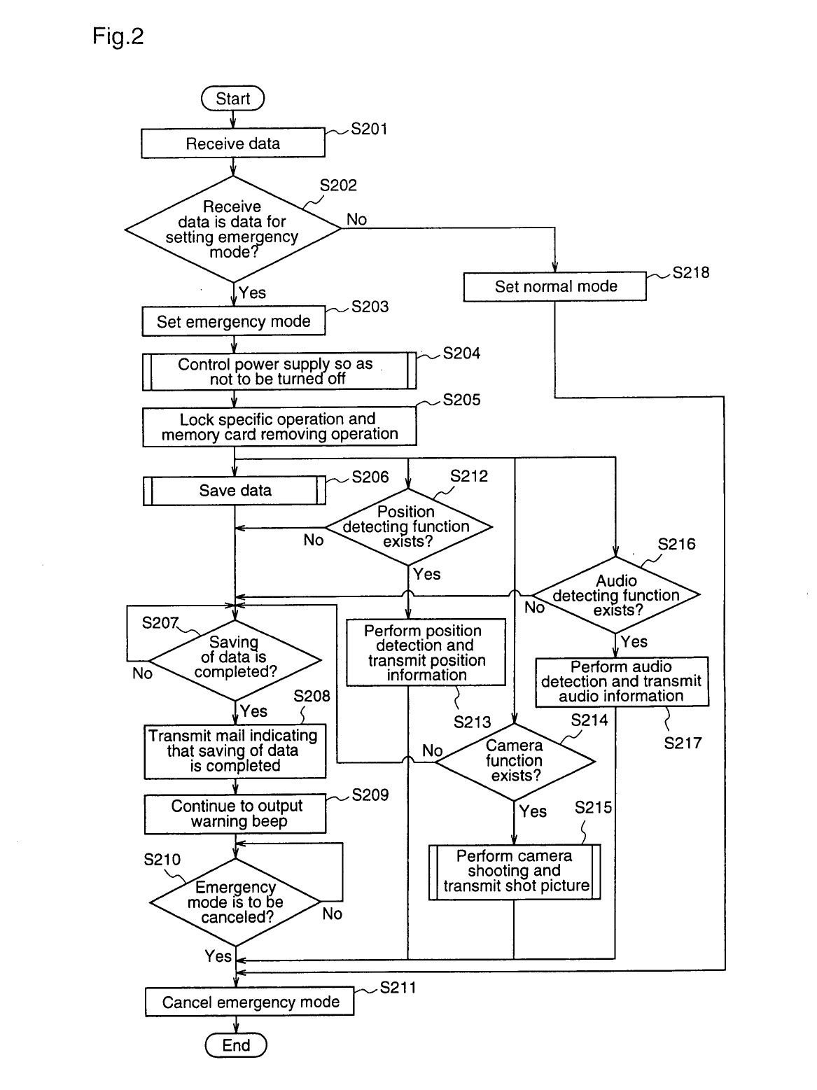

Next, a description will be given of the operation of the mobile terminal device 1001a according to the first embodiment when it receives the emergency data, with reference to FIG. 2.

Initially, the data transmission/reception unit 103 receives external data (step S201), and judges whether the received data is the data for setting the emergency mode or not (step S202). For example, the data transmission/reception unit 103 judges whether the received data is the emergency phone number data, or the emergency mail address data, or the emergency passcode, which is stored in the memory unit 104 or the memory card unit 105. On receipt of the data for setting the emergency mode, the data transmission/reception unit 103 outputs an emergency mode instruction signal to the emergency mode control unit 102. On receipt of the emergency mode instruction signal, the emergency mode control unit 102 sets the respective parts in the emergency mode (step S203), and controls the main power supply 109 so as not to be turned off (step S204).

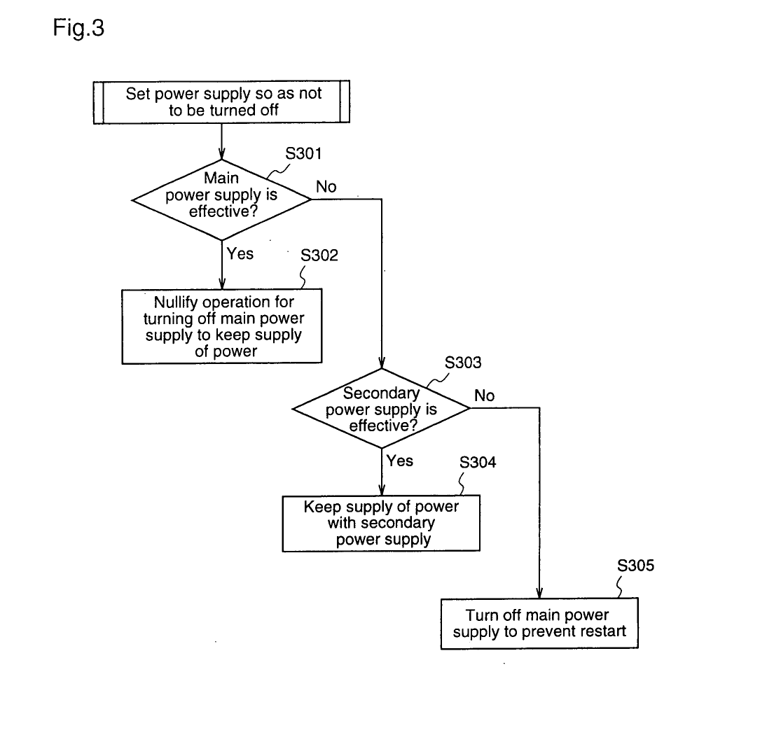

Hereinafter, the power supply control in step S204 will be described in detail with reference to FIG. 3. When the emergency mode control unit 102 controls the power supply so as not to be turned off, initially it judges whether the main power supply 109 is effective or not (step S301). To be specific, the emergency mode control unit 102 judges that the main power supply 109 is effective, when the remaining power of the main power supply 109 exceeds a threshold value. When the main power supply 109 is effective, the emergency mode control unit 102 nullifies the key operation for turning off the power supply or performs control for making the power supply unit nonremovable, thereby nullifying the operation of turning off the main power supply 109, whereby the main power supply 109 continues to supply power to the respective parts (step S302). On the other hand, when the main power supply 109 is not effective, the emergency mode control unit 102 judges whether the secondary power supply 110 is effective or not (step S303). When the secondary power supply 110 is effective, that is, when the remaining power of the secondary power supply 110 exceeds a threshold value, the emergency mode control unit 102 controls the secondary power supply 110 so as to supply power to the respective parts, and thereby the secondary power supply 110 continues to supply power to the respective parts on the basis of the control of the emergency mode control unit 102 (step S304). On the other hand, when it is judged in step S303 that there exists no secondary power supply 110 or the secondary power supply 110 is not effective because the remaining power thereof is lower than the threshold value, the emergency mode control unit 102 turns off the main power supply 109, and restricts the key operation for turning on the power supply, thereby preventing restart (step S305).

After the power supply is controlled so as not to be turned off (step S204), the emergency mode control unit 102 locks specific operations and the operation for taking out the memory card from the memory card unit 105 (step S205). The specific operations are, for example, the operation of browsing the phone number book and the mail address book, and the operation of using the electronic money function. The operation of locking the memory card unit 105 is to operate the memory card unit 105 so that the memory card cannot be taken out of the slot of the memory card unit 105 unless a specific authentication is carried out.

Next, the emergency mode control unit 102 controls the emergency data transmission unit 112 so that the data stored in the memory unit 104 or the memory card unit 105 are transmitted to the predetermined server, terminal, or external device, according to the predetermined priority order (step S206). Thereby, important data are saved.

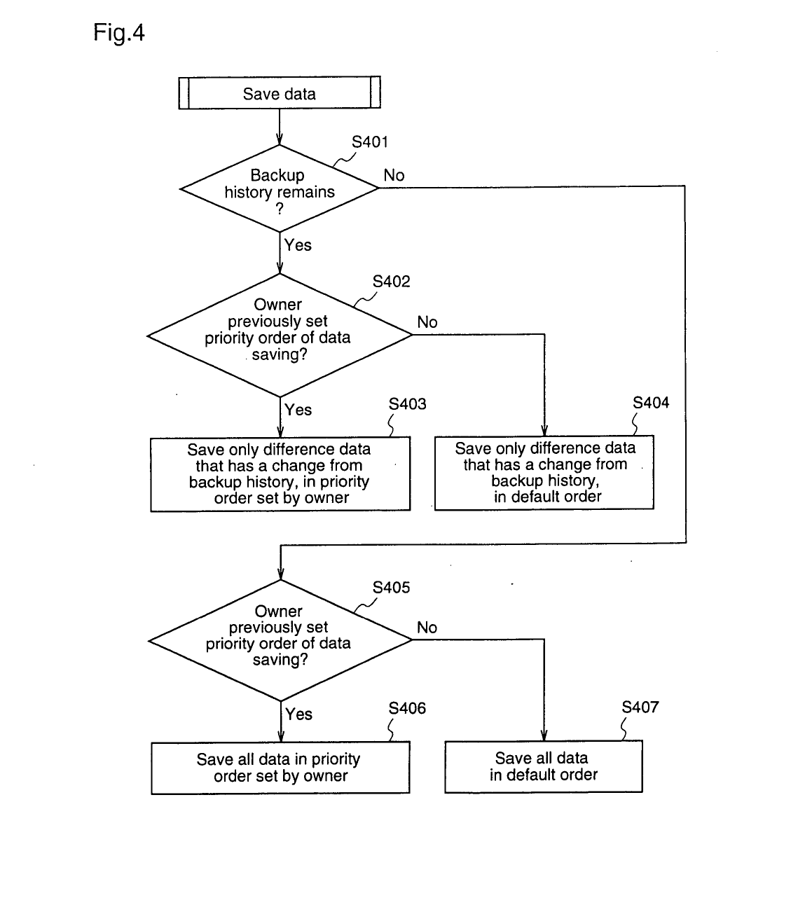

Hereinafter, the data saving process in step S206 will be described in detail with reference to FIG. 4. When the emergency mode control unit 102 performs control for saving the data stored in the memory unit 104 or the memory card unit 105 from the emergency data transmission unit 112 into the predetermined server, terminal, or external device, initially the emergency mode control unit 102 judges whether or not any backup history of data remains in the memory unit 104 or the memory card unit 105 (step S401). When there remains a backup history, the emergency mode control unit 102 judges whether the owner has previously set a priority order of data saving or not (step S402). When a priority order has been set, the emergency mode control unit 102 determines that the data having a change from the backup history, i.e., the data whose data name or data size is changed from the data remaining in the backup history, is difference data, and controls the emergency data transmission unit 112 so that the difference data is saved in the predetermined server, terminal, or external device, according to the priority order that is set by the owner (step S403). Since only the difference data is saved, the data saving time can be reduced. On the other hand, when it is judged in step S402 that the owner has not previously set a priority order of data saving, the emergency mode control unit 102 saves the difference data in a default order into the predetermined server, terminal, or external device (step S404). Further, when the emergency mode control unit 102 judges that there remains no backup history in step S401, it judges whether the owner has previously set a priority order of data saving or not (step S405). When a priority order has already been set, the emergency mode control unit 102 controls the emergency data transmission unit 112 to save all the data into the predetermined server, terminal, or external device according to the priority order set by the owner (step S406). On the other hand, when it is judged in step 405 that the owner has not set a priority order, the emergency mode control unit 102 saves the all data into the predetermined server, terminal, or external device according to a default order (step S407).

When the owner sets a priority order of data saving, the normal mode control unit 101 receives an instruction from the owner to set a priority order during the normal mode, and stores data indicating the priority order in the memory unit 104 or the memory card unit 105. Further, when setting a default order, the maker side previously sets a priority order, and data indicating the priority order is stored in the memory unit 104 or the memory card unit 105.

A position detection process is also carried out in parallel to the data saving process in step S206. In this process, initially, the emergency mode control unit 102 judges whether a position detection function (position detection unit 106) exists or not (step S212). When the position detection unit 106 exists, under control of the emergency mode control unit 102, initially the position detection unit 106 detects the position of the mobile terminal device to generate position information data, and next, the emergency data transmission unit 112 transmits the position information data to the predetermined server, terminal, or external device (step S213). The transmission of the position information data is carried out until the emergency mode is canceled in step S211. The position information data may be once stored in the memory unit 104 or the memory card unit 105 and then transmitted to the predetermined server, terminal, or external device, under control of the emergency mode control unit 102.

As an example of the position detection unit 106, there is proposed a GPS (Global Positioning System) which is a position measurement system using radio wave form satellite. In this case, the mobile terminal device receives GPS information from the satellite, and further, receives base station information from the base station, and transmits the GPS information and the base station information to the predetermined server, terminal, or external device.

Further, an image shooting process using a camera is carried out in parallel with the data backup process in step S206. In this process, initially the emergency mode control unit 102 judges whether a camera function (camera shooting unit 107) exists or not (step S214). When the camera shooting unit 107 exists, under control of the emergency mode control unit 102, initially the camera shooting unit 107 shoots the surrounding circumstances, and then the emergency data transmission unit 112 transmits the shot picture data to the predetermined server, terminal, or external device (step S215). The shot picture data may be once stored in the memory unit 104 or the memory card unit 105 and then transmitted to the predetermined server, terminal, or external device, under control of the emergency mode control unit 102.

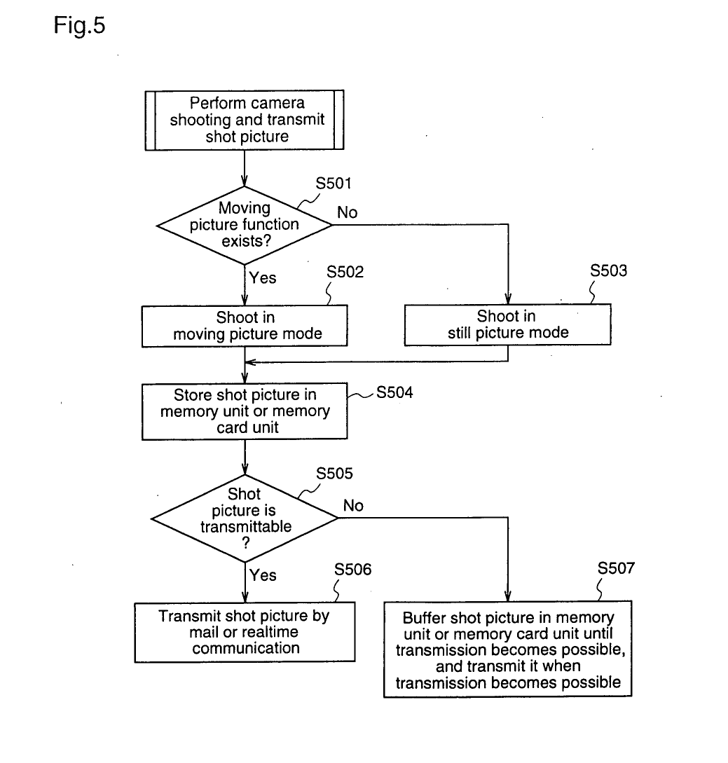

Hereinafter, the camera shooting and the shot picture data transmission in step S215 will be described in detail with reference to FIG. 5. When the mobile terminal device has the camera function (camera shooting unit 107), the emergency mode control unit 102 judges whether the camera shooting unit 107 has a moving picture function or not (step S501). When the moving picture function exists, the camera shooting unit 107 shoots the surrounding circumstances in the moving picture mode (step S502). When there is no moving picture function, the camera shooting unit 107 shoots the surrounding circumstances in the still picture mode (step S503). The shot picture data (moving picture or still picture) is stored in the memory unit 104 or the memory card unit 105 (step S504). Thereafter, the emergency mode control unit 102 judges whether or not the shot picture data can be transmitted to the predetermined server, terminal, or external device (step S505). When the shot picture data can be transmitted, the emergency mode control unit 102 controls the emergency data transmission unit 112 so as to transmit the shot picture data by mail or realtime communication (step S506). On the other hand, when it is judged in step S505 that the shot picture data cannot be transmitted, the emergency mode control unit 102 buffers the shot picture data in the memory unit 104 or the memory card unit 105 until the shot picture data becomes transmittable, and controls the emergency data transmission unit 112 to transmit the shot picture data when the shot picture data becomes transmittable (step S507).

Further, audio detection by the audio detection unit 108 is carried out in parallel with the data saving process in step S206. In this process, initially, the emergency mode control unit 102 judges whether an audio detection function (audio detection unit 108) exists or not (step S216). As an example of the audio detection unit 108, a voice recorder may be employed. When the audio detection unit 108 exists, under control of the emergency mode control unit 102, initially the audio detection unit 108 detects the surrounding sounds, and then the emergency data transmission unit 112 transmits the audio data to the predetermined server, terminal, or external device (step S217). The audio data may be once stored in the memory unit 104 or the memory card unit 105 and then transmitted to the predetermined server, terminal, or external device, under control of the emergency mode control unit 102.

Next, the emergency mode control unit 102 judges whether data saving is completed or not (step S207). When the control unit 102 judges that data saving is completed, it creates a mail indicating that data saving is completed, and transmits the mail through the data transmission/reception unit 103 to the predetermined server or terminal (step S208).

After the mail transmission, the warning beep generation continues to output warning beep under control of the emergency mode control unit 102 (step S209).

When the owner cancels the emergency mode for such reason that the mobile terminal device is found, the owner transmits data for canceling the emergency mode to the mobile terminal device. As the data for canceling the emergency mode, the data that has been transmitted when the emergency mode is set may be used, or other data may be used. For example, in FIG. 10, when the owner sets the emergency mode by making a phone call from the telephone set 1002 for emergency, the owner may cancel the emergency mode by making a phone call from the telephone set 1002 for emergency. Alternatively, the owner may cancel the emergency mode by transmitting a mail from the personal computer 1003, the server 1004, or the mobile terminal 1005.

The emergency mode control unit 102 judges whether or not the data transmission/reception unit 103 receives the data for canceling the emergency mode from the owner (step S210). When it is judged that the data is received, the emergency mode is canceled (step S211).

As described above, in the mobile terminal device according to the first embodiment of the present invention, when the data transmission/reception unit 103 receives the data for setting the emergency mode, the emergency mode control unit 102 controls the power supply so as not to be turned off, and in this state, controls the emergency data transmission unit 112 so that the data stored in the memory unit 104 or the memory card unit 105 are saved into the predetermined server, terminal, or external device. Therefore, when the mobile terminal device of the first embodiment is lost or stolen, the power supply cannot be turned off even if an abuser performs the operation of turning off the power supply, whereby the important data such as personal information data can be saved in the predetermined server, terminal, or external terminal to protect the same.

Further, the mobile terminal device according to the first embodiment is provided with the position detection unit 106 for performing position detection, the camera shooting unit 107 for shooting the surrounding circumstances, and the audio detection unit 108 for detecting the surrounding sounds, and when the data transmission/reception unit 103 receives the data for setting the emergency mode, the emergency mode control unit 102 controls the power supply so as not to be turned off, and in this state, controls the emergency data transmission unit 112 so as to transmit the position information data, the shot picture data, or the audio data to the predetermined server, terminal, or external device. Therefore, when the mobile terminal device according to the first embodiment is lost or stolen, the power supply cannot be turned off even if an abuser performs the operation of turning off the power supply, whereby the current position of the mobile terminal device is continuously informed to the predetermined server, terminal or external device.

Furthermore, in the mobile terminal device according to the first embodiment, when the data transmission/reception unit 103 receives the data for setting the emergency mode, the emergency mode control unit 102 controls the power supply so as not to be turned off, and in this state, controls the warning beep generation unit 111 to output warning beep. Therefore, when the mobile terminal device according to the first embodiment is lost or stolen, the power supply is prevented from being turned off even if an abuser performs the operation of turning off the power supply. Further, the warning beep is continuously outputted to prevent unauthorized use.

While in the first embodiment the mobile terminal device sets the emergency mode when the data transmission/reception unit 103 externally receives, as the data for setting the emergency mode, the phone number data for emergency, the mail address data for emergency, or the passcode for emergency, the present invention is not restricted thereto, and the mobile terminal device may set the emergency mode when the data transmission/reception unit 103 receives other specific data.

While in this first embodiment the mobile terminal device saves the data stored in the memory unit 104 or the memory card unit 105 during the emergency mode, the present invention is not restricted thereto. When saving of the data cannot be carried out, the emergency mode control unit 102 may encrypt or compulsory delete the data stored in the memory unit 104 or the memory card unit 105. Thereby, even when the data cannot be saved, reading of the data and unauthorized use thereof by the abuser can be avoided. Alternatively, after the data saving, the emergency mode control unit 102 may encrypt or compulsory delete the data stored in the memory unit 104 or the memory card unit 105. Thereby, reading of the data and unauthorized use thereof by the abuser can be avoided more reliably. In the case where the data are encrypted, the emergency mode control unit 102 decrypts the data when the emergency mode is canceled.

While in this first embodiment the data stored in the memory unit 104 or the memory card unit 105 are saved by the emergency data transmission unit 112 during the emergency mode, the present invention is not restricted thereto, and the data may be saved by the data transmission/reception unit 103.

While in this first embodiment the mobile terminal device locks the memory card unit 105 during the emergency mode, the present invention is not restricted thereto, and the mobile terminal device may lock the memory card unit 105 when the power supply is in the off state.

While in this first embodiment the mobile terminal device continues to output warning beep after transmission of the mail indicating that data saving is completed, the present invention is not restricted thereto. After the data saving is completed, the emergency mode control unit 102 may turn off the main power supply 109 and operate the power supply so as not to be restarted.

While in this first embodiment the mobile terminal device cancels the emergency mode after the processes in steps S201˜S210, the present invention is not restricted thereto, and the mobile terminal device may cancel the emergency mode any time with an instruction of canceling the emergency mode from the owner.

While in this first embodiment the position information data, the shot picture data, and the audio data are transmitted to the server, terminal or external device by the emergency data transmission unit 112, the present invention is not restricted thereto, and these data may be transmitted by the data transmission/reception unit 103.

Further, in the mobile terminal device of the present invention, the emergency mode control unit 102 may control the display unit 113 so as to display a warning message indicating that data are being saved, during the emergency mode.

### Embodiment 2

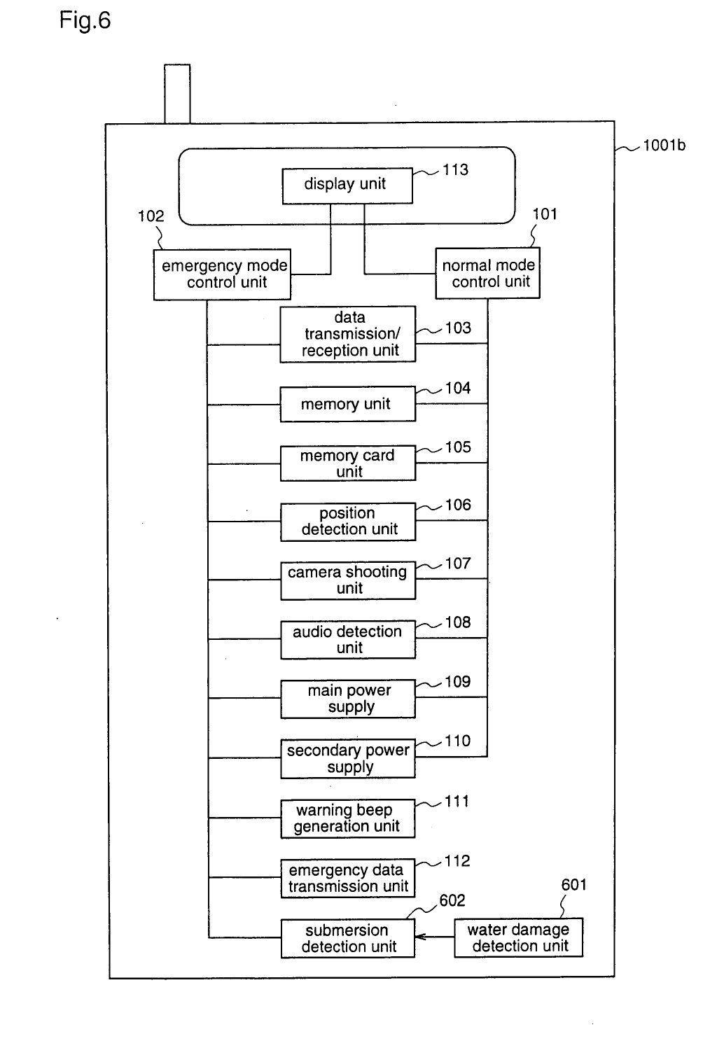

FIG. 6 is a block diagram of a mobile terminal device 1001b according to a second embodiment of the present invention. The mobile terminal device 1001b according to the second embodiment further includes a water damage detection unit 601 and a submersion detection unit 602, in addition to the constituents of the mobile terminal device 1001a according to the first embodiment shown in FIG. 1.

The water damage detection unit 601 detects the degree of water damage of the mobile terminal device 1001b, and outputs the detected value to the submersion detection unit 602. The submersion detection unit 602 judges whether the detected value from the water damage detection unit 601 exceeds a threshold value or not, and judges that the mobile terminal device 1001b is submerged when the detected value exceeds the threshold value. When the submersion detection unit 602 detects that the mobile terminal device 1001b is submerged, it outputs data for setting an emergency mode to the data transmission/reception unit 103.

Hereinafter, the submersion detection method according to the second embodiment will be described in detail.

Generally, the mobile terminal device has a water damage judgement seal whose color becomes deeper when it gets wet. Assuming that the water damage judgement seal is the water damage detection unit 601, the submersion detection unit 602 is provided with a device such as a camera for recognizing the color of the seal, and detects the depth of the color of the seal to judge as to whether the detected value exceeds a predetermined threshold value or not. When the detected value exceeds the threshold value, it is judged that the mobile terminal device is submerged.

For example, a temperature sensor disclosed in Japanese Published Patent Application No. 2001-197175 (Patent Document 4) may be used as the water damage detection unit 601. This temperature sensor comprises such as a semiconductor gas sensor which detects the amount of water including humidity, and converts it into an electric signal. The submersion detection unit 602 receives the electric signal from the temperature sensor, and compares the electric signal level with a threshold value, and decides that the mobile terminal device is submerged when the electric signal level exceeds the threshold value.

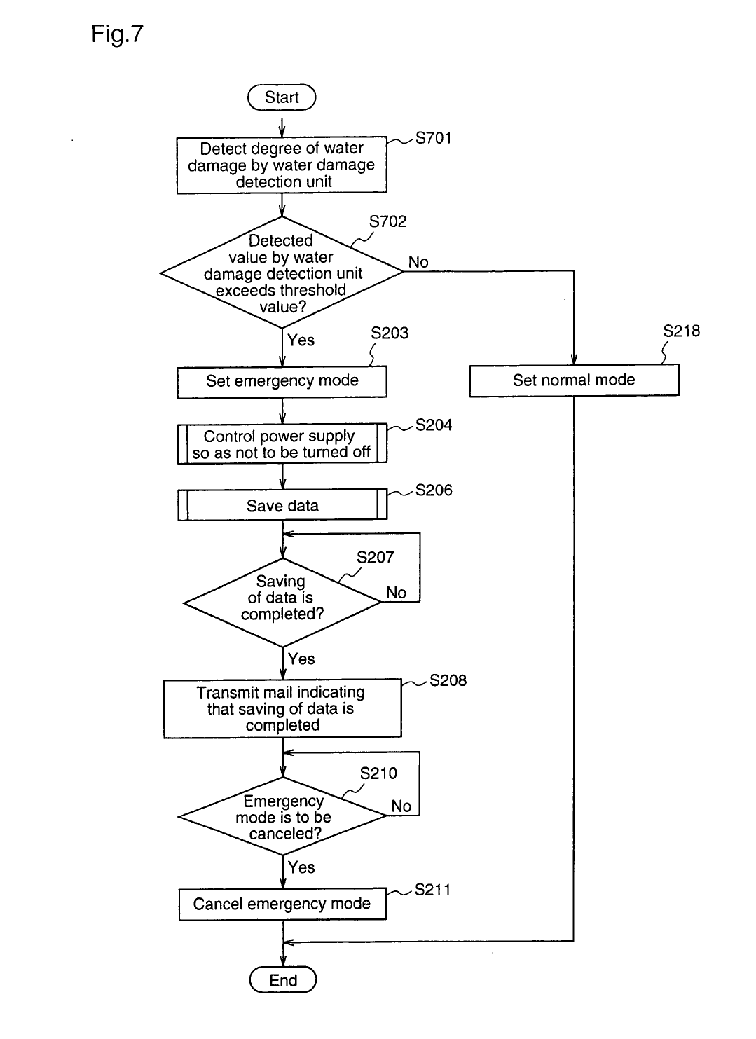

Next, the operation of the mobile terminal device 1001b according to the second embodiment of the present invention will be described with reference to FIG. 7. In the mobile terminal device 1001b according to the second embodiment, the water damage detection unit 601 detects the degree of water damage of the mobile terminal device in preparation for loss of data due to submersion (step S701). The submersion detection unit 602 judges whether the detected value of the water damage detection unit 601 exceeds a threshold value or not (step S702). When the detected value exceeds the threshold value, the submersion detection unit 602 outputs data for setting an emergency mode to the data transmission/reception unit 103.

Thereafter, the mobile terminal device 1001b performs the processes in steps S203, S204, S206˜S208, S210, and S211 shown in FIG. 2. That is, initially, the emergency mode is set, and supply of power from the main power supply 109 or the secondary power supply 110 to the respective units is controlled so as not to be interrupted. Next, all the data stored in the memory unit 104 or the memory card unit 105 or the data that is changed from the backup history are saved into a predetermined server, terminal, or external device, according to a predetermined priority order. When the data saving is completed, a mail indicating that the data saving is completed is transmitted. Thereafter, the emergency mode is canceled according to an instruction for emergency mode cancellation from the owner.

As described above, in the mobile terminal device according to the second embodiment, when the submersion detection unit 602 detects submersion of the mobile terminal device, the emergency mode control unit 102 controls the power supply so as not to be turned off, and in this state, controls the emergency data transmission unit 112 so that the data stored in the memory unit 104 or the memory card unit 105 are saved in the predetermined server, terminal, or external device. Therefore, even when the mobile terminal device of the second embodiment is submerged, the operation in the emergency mode is reliably carried out, whereby the important data such as personal information data can be saved in another terminal, server, or external device to protect the same.

While in this second embodiment the submersion detection unit 602 transmits the data for setting the emergency mode to the data transmission/reception unit 103 when it detects submersion, the present invention is not restricted thereto. The submersion detection unit 602 may output an emergency mode instruction signal to the emergency mode control unit 102 when it detects submersion.

Further, in the mobile terminal device of the present invention, when the submersion detection unit 602 detects submersion of the mobile terminal device, position detection may be carried out by the position detection unit 106 in parallel with the data saving, or the surrounding circumstances may be shot by the camera shooting unit 107, or the surrounding sounds may be detected by the audio detection unit 108, and the position information data, or the shot picture data, or the audio data may be transmitted to the predetermined server, terminal, or external device.

Further, in the mobile terminal device of the present invention, after the data saving, the emergency mode control unit 102 may turn off the main power supply 109. Thereby, the possibility of short-circuiting of the mobile terminal device due to water can be reduced.

Further, in the mobile terminal device of the present invention, when the submersion detection unit 602 detects that the mobile terminal device is submerged, the warning beep generation unit 111 may output warning beep.

### Embodiment 3

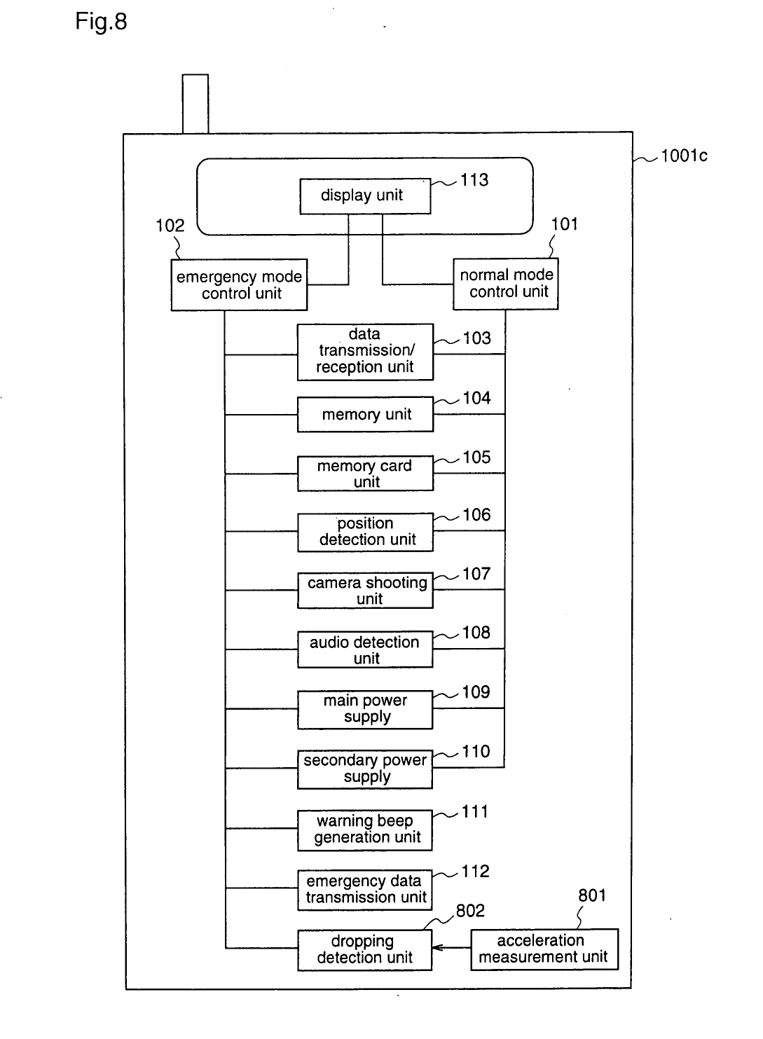

FIG. 8 is a block diagram illustrating a mobile terminal device 1001c according to a third embodiment of the present invention. The mobile terminal device 1001c according to the third embodiment includes an acceleration measurement unit 801 and a dropping detection unit 802, in addition to the constituents of the mobile terminal device 1001a according to the first embodiment shown in FIG. 1.

The acceleration measurement unit 801 measures the acceleration of motion of the mobile terminal device 1001c. The dropping detection unit 802 detects that the mobile terminal device 1001c is being dropped when the acceleration measured by the acceleration measurement unit 801 exceeds a predetermined threshold value. When the dropping detection unit 802 detects dropping of the mobile terminal device 1001c, it outputs data for setting an emergency mode to the data transmission/reception unit 103.

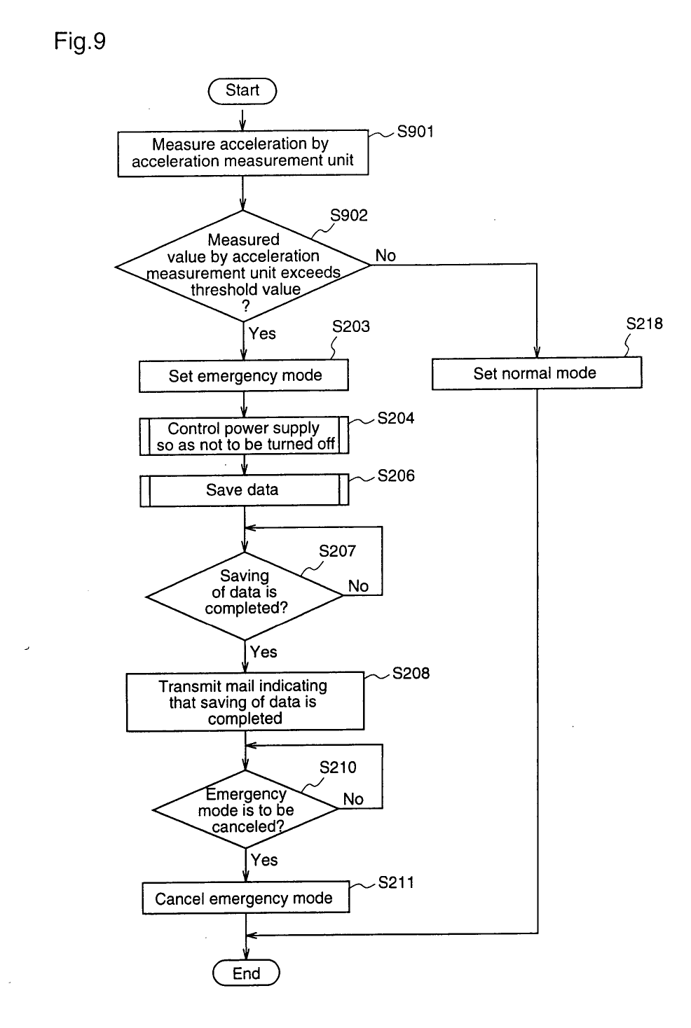

Next, the operation of the mobile terminal device 1001c according to the third embodiment will be described with reference to FIG. 9. In the mobile terminal device 1001c according to the third embodiment, the acceleration measurement unit 801 measures the acceleration of motion of the mobile terminal device in preparation for loss of data due to dropping (step S901). The dropping detection unit 802 judges whether the acceleration measured by the acceleration measurement unit 801 exceeds a threshold value or not (step S902). When the acceleration exceeds the threshold value, the dropping detection unit 802 transmits the data for setting an emergency mode to the data transmission reception unit 103.

Thereafter, the mobile terminal device 1001c performs the processes in steps S203, S204, S206˜S208, S210, and S211 shown in FIG. 2. That is, initially, the emergency mode is set, and supply of power from the main power supply 109 or the secondary power supply 110 to the respective units is controlled so as not to be interrupted. Next, all the data stored in the memory unit 104 or the memory card unit 105 or the data that is changed from the backup history are saved into a predetermined server, terminal, or external device, according to a predetermined priority order. When the data saving is completed, a mail indicating that the data saving is completed is transmitted. Thereafter, the emergency mode is canceled according to an instruction for emergency mode cancellation from the owner.

As described above, in the mobile terminal device according to the third embodiment, when the dropping detection unit 802 detects dropping of the mobile terminal device, the emergency mode control unit 102 controls the power supply so as not to be turned off, and in this state, controls the emergency data transmission unit 112 so that the data stored in the memory unit 104 or the memory card unit 105 are saved in the predetermined server, terminal, or external device. Therefore, according to the third embodiment, even when the mobile terminal device is being dropped, the operation in the emergency mode is reliably carried out, whereby the important data such as personal information data can be saved in another terminal, server, or external device to protect the same.

While in this third embodiment the dropping detection unit 802 transmits the data for setting the emergency mode to the data transmission/reception unit 103 when it detects dropping, the present invention is not restricted thereto. The dropping detection unit 802 may output an emergency mode instruction signal to the emergency mode control unit 102 when it detects dropping.

Further, in the mobile terminal device of the present invention, when the dropping detection unit 802 detects dropping of the mobile terminal device, position detection may be carried out by the position detection unit 106 in parallel with the data saving, or the surrounding circumstances may be shot by the camera shooting unit 107, or the surrounding sounds may be detected by the audio detection unit 108, and the position information data, or the shot picture data, or the audio data may be transmitted to the predetermined server, terminal, or external device.

Further, in the mobile terminal device of the present invention, when the dropping detection unit 802 detects dropping of the mobile terminal device, the warning beep generation unit 111 may output warning beep.

In the first to third embodiments, the mobile terminal device sets the emergency mode when the data transmission/reception unit 103 externally receives, as data for setting the emergency mode, the data of phone number for emergency, or the data of mail address for emergency, or the passcode for emergency, or when the transmission/reception unit 103 receives the data for setting the emergency mode from the submersion detection unit 602 or the dropping detection unit 802. However, the present invention is not restricted thereto.

For example, when the present invention is a mobile terminal device that allows the power on/off operation and the normal operation after authentication of the owner (fingerprint, iris, voice, etc.) is performed, the normal mode control unit 101 detects whether or not the power-off operation is carried out after the authentication, and transmits the data for setting the emergency mode to the data transmission/reception unit 103 if the power-off operation is carried out before the authentication.

When the present invention is a mobile terminal device having an input unit that receives an instruction of the emergency mode from the owner, the input unit transmits data for setting the emergency mode to the data transmission/reception unit 103 when it receives the instruction of the emergency mode.

### APPLICABILITY IN INDUSTRY

The present invention is useful as a mobile terminal device that protects important data such as personal information data when an accident such as theft, loss, submersion, or dropping occurs.

1. A mobile terminal device comprising:
a main power supply for supplying power;
a data transmission/reception unit for transmitting and receiving data;
a memory unit for storing data;
an emergency data transmission unit for transmitting data to a predetermined server, terminal, or external device; and
a control unit for making the main power supply not to be turned off when the data transmission/reception unit receives data for setting an emergency mode, and in this state, controlling the emergency data transmission unit so as to transmit the data stored in the memory unit to the predetermined server, terminal, or external device.

2. A mobile terminal device as defined in claim 1 wherein
the memory unit stores a phone number for emergency, and
when the data transmission/reception unit receives data of the phone number for emergency as the data for setting the emergency mode, the control unit makes the main power supply not to be turned off, and in this state, controls the emergency data transmission unit so as to transmit the data stored in the memory unit to the predetermined server, terminal, or external device.

3. A mobile terminal device as defined in claim 1 wherein
the memory unit stores a mail address for emergency, and
when the data transmission/reception unit receives data of the mail address for emergency as the data for setting the emergency mode, the control unit makes the main power supply not to be turned off, and in this state, controls the emergency data transmission unit so as to transmit the data stored in the memory unit to the predetermined server, terminal, or external device.

4. A mobile terminal device as defined in claim 1 wherein
the memory unit stores a passcode for emergency, and
when the data transmission/reception unit receives the passcode for emergency as the data for setting the emergency mode, the control unit makes the main power supply not to be turned off, and in this state, controls the emergency data transmission unit so as to transmit the data stored in the memory unit to the predetermined server, terminal, or external device.

5. A mobile terminal device as defined in claim 1 further including:
a position detection unit for detecting the position of the mobile terminal device, and outputting position information data; and
said control unit controlling the emergency data transmission unit so as to transmit the position information data to the predetermined server, terminal, or external device, when the data transmission/reception unit receives the data for setting the emergency mode.

6. A mobile terminal device as defined in claim 1 further including:
a shooting unit for shooting surrounding circumferences, and outputting shot picture data; and
said control unit controlling the emergency data transmission unit so as to transmit the shot picture data to the predetermined server, terminal, or external device, when the data transmission/reception unit receives the data for setting the emergency mode.

7. A mobile terminal device as defined in claim 1 further including:
an audio detection unit for detecting surrounding sounds, and outputting audio data; and
said control unit controlling the emergency data transmission unit so as to transmit the audio data to the predetermined server, terminal, or external device, when the data transmission/reception unit receives the data for setting the emergency mode.

8. A mobile terminal device as defined in claim 1 further including:
a secondary power supply; and
said control unit controlling the second power supply so as to supply power, if the main power supply cannot supply power when the data transmission/reception unit receives the data for setting the emergency mode.

9. A mobile terminal device as defined in claim 1 further including:
a warning beep generation unit for generating warning beep; and
said control unit controlling the warning beep generation unit so as to generate warning beep, when the data transmission/reception unit receives the data for setting the emergency mode.

10. A mobile terminal device as defined in claim 1 wherein
said memory unit stores backup history indicating the history of data which have been transmitted in the past from the memory unit to the predetermined server, terminal, or external device, and
said control unit controls the emergency data transmission unit so as to transmit data which has a change in its data name or data size from the data remaining in the backup history, as difference data, to the predetermined server, terminal, or external device, when the data transmission/reception unit receives the data for setting the emergency mode.

11. A mobile terminal device as defined in claim 1 further including:
a water damage detection unit for detecting the degree of water damage on the mobile terminal device; and
a submersion detection unit for detecting whether the mobile terminal device is submerged or not, based on whether a detected value by the water damage detection unit exceeds a threshold value or not, and transmitting the data for setting the emergency mode to the data transmission/reception unit when submersion of the mobile terminal device is detected.

12. A mobile terminal device as defined in claim 1 further including:
an acceleration measurement unit for measuring the acceleration of motion of the mobile terminal device; and
a dropping detection unit for detecting whether the mobile terminal device is being dropped or not, based on whether the acceleration measured by the acceleration measurement unit exceeds a threshold value or not, and transmitting the data for setting the emergency mode to the data transmission/reception unit when dropping of the mobile terminal device is detected.
